(19) United States
(12) Patent Application Publication
(10) Pub. No.: US 2008/0315152 A1
(43) Pub. Date: Dec. 25, 2008

(54) HEAT TRANSFER FLUID

(76) Inventor: GLENDON C. DALY, East Lansing, MI (US)

Correspondence Address: Mary M. Moyne;Fraser Trebilcock Davis & Dunlap, P.C., Suite 1000, 124 West Allegan Street, Lansing, MI, 48933, US

(21) Appl. No.: 11/766,992

(22) Filed: Jun. 22, 2007

(51) Int. Cl. C09K 5/00

(52) U.S. Cl. 252/73; 165/48.1

(57) ABSTRACT

A heat transfer fluid comprised of glycerin. A method of using the heat transfer fluid to heat or cool an object. A method of using the heat transfer fluid in a heating or cooling system to heat or cool a building.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) Field of the Invention

The present invention relates to a heat transfer fluid having glycerin.

(2) Description of the Related Art

Water is the current choice of conductivity for heating and cooling transfer fluids. Water is readily available and inexpensive. However, water will freeze at 32° F. (0° C.) and can create corrosion as the temperature rises. Furthermore, since water boils at 212° F. (100°), water is only an average conductor of cold and heat. Some industries add either ethylene or propylene glycol to the water as a way to lower the freezing point or raise the boiling point of the water. Alcohols have also been used; however, alcohols are very volatile, flammable and explosive. Chlorides and acetates have been used, but are limited in the temperature range in which they can be used. In addition, chlorides and acetates are corrosive.

In the past, various compositions have been used as heat transfer compositions. In particular, U.S. Pat. No. 6,086,782 to Hsu et al. describes a heat transfer fluid composition comprising at least one terpene and at least one alkylbenzene. The heat transfer fluid is specifically used for low temperature heat transfer processes between the range of 0° F. and −142° F. (−18° C. and 61° C.). The heat transfer fluid is non-toxic, non-hazardous and biodegradable.

In addition, U.S. Pat. No. 5,141,662 to Dexheimer et al. describes a heat transfer fluid having a high thermal stability comprised of certain polyether polyols for use in high temperature applications. The polyether polyols are prepared by reacting one or more saccharides or mixtures thereof with alkylene oxide.

There remains a need for an inexpensive heat transfer fluid that is non-toxic, non-hazardous and biodegradable.

### SUMMARY OF THE INVENTION

A heat transfer fluid having glycerin. The heat transfer fluid is biodegradable, non-toxic, non-flammable and non-caustic. In one (1) embodiment, the glycerin is a by-product produced during the production of biodiesel. In one (1) embodiment, the glycerin is derived from a non-petroleum product. The glycerin can be derived from plants or animals. The glycerin contains at least about 60% by weight glycerol. In one (1) embodiment the glycerin is animal feed grade glycerin and contains less than 3% methanol. The heat transfer fluid is non-corrosive and has a freezing temperature as low as −51° F. (−46° C.). In one (1) embodiment, the heat transfer fluid includes a mix of 50% by weight glycerin and 50% by weight water and the mix makes up between about 0.005% to 70% by weight of the heat transfer fluid. In one (1) embodiment, the heat transfer fluid has a freezing point of at least −45° F. (−43° C.) and a boling point of greater than 350° F. (177° C.). In one (1) embodiment, the heat transfer fluid has a corrosion level of less than 3 mg per day at 220° F. (104.4° C.).

The glycerin can be combined with other ingredients to form the heat transfer fluid. Additional ingredients such as water, desugared molasses, lignins, whey, brewers yeast, lanolin, condensed corn fermented extracts, corn condensed distillers solubles, ethylene glycol, propylene glycol, calcium chloride, sodium chloride, magnesium chloride, potassium chloride, ethanol, ethyl alcohol, isopropyl alcohol, methyl alcohol, windshield washer solvent, salts or acetates can be included in the heat transfer fluid. Some of the ingredients are added to the heat transfer fluid to lower the freezing point of the heat transfer fluid. The glycerin in the heat transfer fluid easily mixes with the other ingredients to form a consistent liquid. The amount of glycerin in the heat transfer fluid depends on the type of environment in which the heat transfer fluid is used and the temperature of the environment. In one (1) embodiment, the heat transfer fluid includes at least 50% by weight glycerin. In one (1) embodiment, the heat transfer fluid includes at least 60% by weight glycerin. In one (1) embodiment, the amount of the additional ingredients in the heat transfer fluid is greater that an amount of glycerin in the heat transfer fluid.

The heat transfer fluid can be used to heat or cool an object and can be used in heating and cooling systems for heating and cooling residential, commercial and industrial buildings. The heat transfer fluid can be used in an engine cooling system. To cool a vehicle having a radiator and an engine block, the heat transfer fluid is moved through the engine block to transfer heat from the engine block to the heat transfer fluid. The heat transfer fluid then moves through the radiator to transfer heat from the heat transfer fluid to the radiator and to air surrounding the radiator.

When used in a heating and cooling system for a building, the heat transfer fluid is inserted into the pipes of the heating and cooling system. The heating or cooling systems can include a boiler, pipes, a radiator, and a pump. The heat transfer fluid is then moved into contact with the boiler so that heat is transferred from the boiler to the heat transfer fluid. The heat transfer fluid then moves through the radiators of the heating and cooling system and heat is transferred from the heat transfer fluid to the radiators. Heat is then transferred from the radiators to air surrounding the radiators and into the building to heat the air in the building. In one (1) embodiment, the heating and cooling system has a pump and a storage tank connected to a radiator in a building by pipes which are located underground. The heat transfer fluid is pumped from the storage tank through the pipes to the radiator. As the heat transfer fluid is moved through the pipes, the heat is transferred from the heat transfer fluid to the surrounding ground so that the heat transfer fluid is cooled. Heat is then transferred to the heat transfer fluid in the radiator from the air surrounding the radiator which cools the air in the building. The heat transfer fluid can be used in any system which currently uses water or a water and glycol mixture as the heat transfer fluid. In one (1) embodiment, the heating and cooling system is a commercial chiller.

The present invention relates to a heat transfer fluid which comprises glycerin.

Further, the present invention relates to a method for conducting heat transfer in a heating or cooling system, which comprises the steps of providing a heat transfer fluid in the heating or cooling system wherein the heat transfer fluid includes glycerin, and conducting heat transfer between the heat transfer fluid and the heating or cooling system.

Still further, the present invention relates to a method of heat transfer comprising the steps of providing an object to be heated or cooled, and transferring heat to or from the object to be heated or cooled by means of a heat transfer fluid, the heat transfer fluid comprising glycerin.

The substance and advantages of the present invention will become increasingly apparent by reference to the following drawings and the description.

### BRIEF DESCRIPTION OF THE DRAWINGS

FIG. 1 is a schematic representation of a hot water heating system 20 for a building 12 using the heat transfer fluid 10.

FIG. 2 is a schematic representation of a heating and cooling system 30 for a building 12 using the heat transfer fluid 10.

FIG. 3 is a schematic representation of a heating and cooling system 30 having heating or cooling coils 35 in the floor 14 of the building 12.

FIG. 4 is a schematic representation of a vehicle engine showing the engine cooling system 50 having the heat transfer fluid 10.

### DETAILED DESCRIPTION OF THE PREFERRED EMBODIMENTS

All patents, patent applications, government publications, government regulations, and literature references cited in this specification are hereby incorporated herein by reference in their entirety. In case of conflict, the present description, including definitions, will control.

A heat transfer fluid 10 having glycerin. A heat transfer fluid 10 is a gas or liquid used to move heat energy from one (1) place to another. The heat transfer fluid 10 can be used in heating and cooling systems 20 and 30 such as hot water heat systems 20, conventional air conditioning systems, geothermal heating systems 30, solar water heating systems and chillers. The heat transfer fluid 10 can also be used to cool or object such as a vehicle engine 50.

The heat transfer fluid 10 of the present invention includes glycerin (glycerine) or glycerol. Glycerol is the chemical name for the chemical compound 1,2,3-propanetriol. The common commercial name used in the United States for products whose principal component is glycerol is glycerin. In one (1) embodiment, glycerin contains greater than 95% by weight glycerol. In one (1) embodiment, the glycerin used in the heat transfer fluid 10 is industrial-grade glycerin which contains between about 80% by weight to 90% by weight glycerol. In one (1) embodiment, the glycerin is not derived from petroleum. Glycerin can be produced as a by-product of the processing of animal fats and oils or vegetables or fruit oils using transesterification such as in the production of biodiesel or using saponification such as in the production of soaps. In one (1) embodiment, the glycerin is derived from a plant, alcohol, or animal source such as tallow, fat or crop oils. In one (1) embodiment, the glycerin is a by-product of the processing of oils from agricultural crops such as soybeans, corn, palms, coconut, cotton, citrus oils, rapeseed, grape seeds, canola, flax, safflower, sunflowers, cherry pits, nuts or seeds.

In one (1) embodiment, the glycerin is crude glycerin. Crude glycerin is a by-product created during the transesterification process used to create biodiesel. The crude glycerin contains a mixture of glycerin, methanol, water, inorganic salts, free fatty acids, unreacted mono-, di-, and triglycerides, methyl esters and a variety of other organic non-glycerol matter in varying quantities. Crude glycerin is very soluble and heavy with fats and methanol. Crude glycerin solidifies very easily. In one (1) embodiment, the crude glycerin is frozen solid at 0° C. (32° F.). Crude glycerin has a pH of between about 7.8 to 13.5 and contains about 70-80% by weight glycerol and has a methanol level of up to 35%. The methanol is removed from the crude glycerin and the crude glycerin is neutralized to produce a neutralized crude glycerin. In one (1) embodiment, the crude glycerin is neutralized from a high pH in the range of about 7.8 to 13.5 to a pH in the range of about 3.0 to 7.3. Neutralized crude glycerin has a high salt and free fatty acid content. In one (1) embodiment, neutralized crude glycerin contains approximately 65.8% by weight glycerol, about 45,000 ppm of chloride and about 16,500 ppm of sulfate and has a specific gravity at 77° F. (25° C.) of 1.1315. The crude glycerin can be refined to produce other grades of glycerin. In one (1) embodiment, the glycerin is animal feed grade glycerin which has less than 2% methanol. In one (1) embodiment, the animal feed grade glycerin has less than 1% methanol. In one (1) embodiment, the animal feed grade glycerin has a methanol level of between about 0.001 to 0.009%, with the water removed and a glycerol level of between about 80 to 99%. In one (1) embodiment, the glycerin is food grade or pharmaceutical grade glycerin. The impurities act to maintain or hold the heat or cold in the heat transfer fluid.

In one (1) embodiment, the glycerin has a flash point of greater than 350° F. (177° C.) Pensky-Martens Closed Cup (PMCC), is completely water soluble at 72° F. (22° C.) and will not decompose at temperatures less than 400° F. (204° C.). In one (1) embodiment, the glycerin has a boiling point of approximately 264° F. (129° C.). In one (1) embodiment, the glycerin will not stratify or separate out at temperatures of less than approximately 350° F. (177° C.). The contents and characteristics of the glycerin will vary depending on the process used to produce the glycerin. The amount of impurities in the glycerin will affect the boiling and freezing temperature of the heat transfer fluid. In one (1) embodiment, pharmaceutical grade glycerin has a pH of about 3 or lower and has a methanol level of less than about 0.0025%. Table 1 shows the impurities and the amount of impurities in one (1) sample of animal feed grade glycerin. The sample had a conductivity of 1100 μS/cm. It is understood that the content of the glycerin including the types and percentages of impurities will vary depending on the starter product used to produce the glycerin as well as the process used to produce the glycerin.

TABLE 1

| | mg/L |
|---|---|
| Cations/Metals - Total | |
| Aluminum (Al) | 2.0 |
| Barium (Ba) | <0.4 |
| Boron (B) | <0.1 |
| Cadmium (Cd) | <0.04 |
| Calcium (Ca) | 48 |
| Chromium (Cr) | <0.01 |
| Copper (Cu) | 0.16 |
| Iron (Fe) | 4.6 |
| Lead (Pb) | <0.2 |
| Lithium (Li) | <0.01 |
| Magnesium (Mg) | 4.5 |
| Manganese (Mn) | 0.21 |
| Molybdenum (Mo) | <0.1 |
| Nickel (Ni) | <0.1 |
| Phosphorus (P) | <1.1 |
| Potassium (K) | 6.3 |
| Silica (SiO2) | 11.0 |
| Sodium (Na) | 180 |
| Strontium (Sr) | 0.13 |
| Vanadium (V) | <0.53 |
| Zinc (Zn) | 0.07 |
| Anions | |
| Bromide (Br) | <2.0 |
| Chloride (Cl) | 200 |
| Nitrate (NO3) | <2.0 |
| Nitrite (NO2) | <2.0 |
| Sulfate (SO4) | 34 |

Glycerin is combined with other ingredients to form the heat transfer fluid 10. The various ingredients are added with the glycerin to change the characteristics of the heat transfer fluid 10. The exact mix of glycerin and other ingredients used to form the heat transfer fluid will depend on the application and temperature range of use for the heat transfer fluid 10. Some of the ingredients that can be combined with glycerin include water, desugared molasses, lignins, whey, brewers yeast, lanolin, condensed corn fermented extractives and corn condensed distillers solubles. Use of desugared molasses in as a heat transfer fluid is shown in a co-pending U.S. patent application Ser. No. 10/910,921 titled Heat Transfer Fluid filed on Aug. 4, 2004, which is incorporated herein by reference in its entirety. The amount of other ingredients in the heat transfer fluid 10 may be greater than the amount of glycerin in the heat transfer fluid 10. In one (1) embodiment, the glycerin is combined with water to form a mix. In one (1) embodiment, the mix is 50% glycerin and 50% water. In one (1) embodiment, the mix makes up between about 0.005% to 70% by weight of the heat transfer fluid 10. In one (1) embodiment, the heat transfer fluid 10 includes 15% by weight glycerin and 85% by weight desugared molasses. The heat transfer fluid 10 having this mixture flows and pours readily at approximately −28° F. (−33° C.). In addition, the heat transfer fluid 10 including glycerin and desugared molasses produces less foam than a heat transfer fluid containing desugared molasses without the addition of glycerin.

The heat transfer fluid 10 may contain other various ingredients, in addition to the glycerin, which are added to change the properties of the heat transfer fluid 10. The amount of various other ingredients in the heat transfer fluid 10 may be greater than the amount of glycerin in the heat transfer fluid 10. Glycerin readily mixes with many ingredients, such as water, alcohols, glycol (ethylene and propylene), windshield washer solvent, chlorides (calcium, magnesium, sodium, potassium), salts and acetates (potassium, calcium, magnesium). The ingredients can be added to lower the freezing point of the heat transfer fluid 10 or change the corrosion rate of the heat transfer fluid 10. In one (1) embodiment, water is added to the heat transfer fluid 10 to reduce the freezing point of the heat transfer fluid 10. A heat transfer fluid 10 having essentially 100% by weight of glycerin and 0% by weight of water has a freezing point of about 62.6° F. (17.0° C.). In contrast, a heat transfer fluid 10 having about 66.7% by weight glycerin and approximately 33.3% by weight water has a the freezing point of approximately −51.7° F. (−46.6° C.). In one (1) embodiment, the heat transfer fluid 10 has at least 30% by weight water and has a freezing point of at least about −38° F. (−38.9° C.).

In one (1) embodiment, alcohols or glycols, such as ethylene glycol, propylene glycol, ethanol, ethyl alcohol, isopropyl alcohol, methyl alcohol or combinations of alcohols and glycols are included in the heat transfer fluid 10 to lower the freezing point of the heat transfer fluid 10. In one (1) embodiment, the alcohol or glycol is added to the heat transfer fluid 10 by first adding the alcohol or glycol to water and then adding the glycerin to the water and alcohol or water and glycol solution. Ethyl glycol or propylene glycol can also be included in the heat transfer fluid 10 to provide an additional anti-corrosion benefit. At high temperatures, corrosion may occur as a result of the oxygen in the water used as the carrier in the heat transfer fluid 10. The amount of ethylene glycol or propylene glycol included in the heat transfer fluid 10 is in the range of about 1% by weight to 95% by weight, depending upon the application, temperature range, and corrosion conditions. Other products such as sodium nitrate, sodium molyhydrate, and sodium hydroxide can also be added as a non-corrosive agent for the water. In one (1) embodiment, less than 1% by volume of each of the non-corrosion agents is required to reduce corrosion.

In one (1) embodiment, windshield washer solvent is added as an ingredient to lower the freezing point of the heat transfer fluid 10. As used in this application, windshield washer solvent is defined as any liquid designed for use in a motor vehicle windshield washer system either as antifreeze or for the purpose of cleaning, washing, or wetting the windshield. The windshield washer solvent mixes easily with other ingredients and can replace water as the Liquid carrier in the heat transfer fluid 10. In one (1) embodiment, the windshield washer solvent includes methanol as its main ingredient. In one (1) embodiment, the windshield washer solvent includes isopropyl alcohol as its main ingredient. In one (1) embodiment, adding windshield washer solvent to the heat transfer fluid 10 produces a pH of about 7 in the heat transfer fluid 10.

The amount of alcohols, glycols or windshield washer solvents added to the heat transfer fluid 10 will vary depending upon the temperature in the region. In one (1) embodiment, the heat transfer fluid 10 contains between about 1% by weight and 50% by weight alcohol or glycol. A heat transfer fluid 10 having about 50% by weight alcohol and 50% by weight glycerin has a freezing point of approximately −28° F. (−33° C.), whereas a heat transfer fluid 10 having about 90% by weight glycerin and 10% by weight alcohol has a freezing point of approximately 28° F. (−2° C.). In one (1) embodiment, the amount of alcohol, glycol or windshield washer solvent in the heat transfer fluid 10 is greater than the amount of glycerin in the heat transfer fluid 10.

In one (1) embodiment, salts such as mineral well or oil well brine or chlorides such as calcium chloride, magnesium chloride, potassium chloride, sodium chloride or acetates are added to the heat transfer fluid 10 to lower the freezing point of the heat transfer fluid 10. The combination of glycerin with the salts or chlorides produces a heat transfer fluid 10 which is less corrosive than heat transfer fluids which include either only salts or chlorides or combinations of salts and chlorides without the glycerin. The use of glycerin in the heat transfer fluid 10 reduces the amount of corrosion caused by the salts or chlorides. In one (1) embodiment, the amount of salts or the amount of chlorides or the combination of salts and chlorides in the heat transfer fluid 10 is greater than the amount of glycerin in the heat transfer fluid.

The heat transfer fluid 10 is used in heating and cooling systems 20 and 30 to heat and cool industrial, commercial and residential buildings or power plants. In one (1) embodiment, the heating and cooling system 20 is a hot water system. In one (1) embodiment, the heating and cooling system is an air conditioning system. In one (1) embodiment, the heating and cooling system 30 is a geothermal system. In one (1) embodiment, the heating and cooling system is a chiller which cools to subzero temperatures. In one (1) embodiment, where the heat transfer fluid 10 is used in a chiller, the heat transfer fluid 10 reduced to a temperature to between about 32° F. to −51° F. (0° C. to 46° C.) by passing the coils having the heat transfer fluid through dry ice or liquid nitrogen. The heat transfer fluid 10 can also be used to heat and cool objects such as vehicle engines. The heat transfer fluid 10 can be pumped through small openings in engines and heating or cooling systems and through massive pipes to heat or cool turbines, power plants, nuclear plants, homes and businesses. In one (1) embodiment, the heat transfer fluid 10 is particularly useful for heat transfer applications between the range of approximately −45° F. (−43° C.) to 350° F. (177° C.). The heat transfer fluid 10 can be pumped at temperatures as low as −51° F. (−46° C.) below zero. The heat transfer fluid 10 can be used for low temperature applications or processes with temperatures as low as −51° F. (−46° C.) below zero. The heat transfer fluid 10 remains in a liquid state and does not freeze or become solid at temperatures up to as low as approximately −51° F. (−46° C.). The heat transfer fluid has a pH in a range of 5 to 9. The heat transfer fluid has a boiling point of greater than 200° F. (93° C.).

The heat transfer fluid 10 acts as an anti-corrosion material for the heating and cooling systems 20 and 30 and other equipment. The heat transfer fluid 10 is hygroscopic and absorbs free water molecules within the equipment into the heat transfer fluid 10 which helps to reduce corrosion of the equipment. The non-corrosive properties of the heat transfer fluid 10 allow the heat transfer fluid 10 to be used as a protector for the equipment used with the heat transfer fluid 10. When the neutralized crude glycerin is heated to 200° F. (93° C.) for several hours, the corrosion rate was less than or equal to 5 mills per year (mpy). The addition of between about 4 to 20 parts per million (ppm) of sodium nitrate as corrosion inhibitors reduces the rate of corrosion to under 1 mpy by adding. At temperatures under 150° F. (65.6° C.), the corrosion rate is less than ½ mpy. In one (1) embodiment, a heat transfer fluid 10 including about 50% by weight feed grade glycerin and about 50% by weight water has a corrosion rate of less than 3 mg per day at 220° F. (104.4° C.). In one (1) embodiment, a heat transfer fluid 10 containing a mix of feed grade glycerin and water and a mix of sodium nitrate and sodium molybdate with the sodium nitrate and sodium molybdate mix comprising less than 3% by weight of the total volume of the heat transfer fluid 10, has a the corrosion rate of less than 1½ mg per day. The heat transfer fluid 10 helps control corrosion in heating, cooling, air conditioning, chiller, solar, and geothermal systems. The glycerin in the heat transfer fluid 10 also acts as a lubricant for the equipment of the heating and cooling systems 20 and 30. The glycerin reduces the friction between the moving parts of the equipment of the heating and cooling systems 20 and 30 and thus reduces wear on the equipment. It is believed that the fatty triglycerides of the glycerin create the lubricating effect.

The heat transfer fluid 10 can be stored in steel, plastic, poly or stainless steel containers. The heat transfer fluid 10 can be pumped from the storage container into the heating and cooling systems or the objects to be heated or cooled by most types of pumps well known in the art such as gear, air, diaphragm, roller, or piston. The heat transfer fluid 10 having approximately 66% by weight glycerin and approximately 34% by weight water flows at very low temperatures of approximately −45° F. (−43° C.).

The heat transfer fluid 10 has better heat and cold retaining ability than water or other heat transfer fluids such as glycols and ethanols. The heat transfer fluid 10 when heated to between about 32° to 220° F. (0° to 104° C.) will hold heat longer, allowing for more efficient use of the heat source. Testing of the heat transfer fluid 10 having glycerin showed that the heat transfer fluid 10 having glycerin retained heat better than a heat transfer fluid comprised of tap water. Equal amounts of conventional tap water and glycerin were tested for heat retaining properties. The amount of each heat transfer fluid tested was one (1) pint.

Table 2 shows the heat capacity of the heat transfer fluid having different percentages by weight of glycerin and water.

TABLE 2

| | |
|---|---|
| Heat Transfer | |
| Fluid Mix | |
| % by weight | Heat Capacity |

| Glycerin | Water | J/g ° C. | BTU/lb ° F. |
|---|---|---|---|
| 100 | 0 | 2.7 | 0.640 |
| 40 | 60 | 4.06 | 0.971 |
| 50 | 50 | 3.24 | 0.775 |
| 60 | 40 | 3.10 | 0.743 |

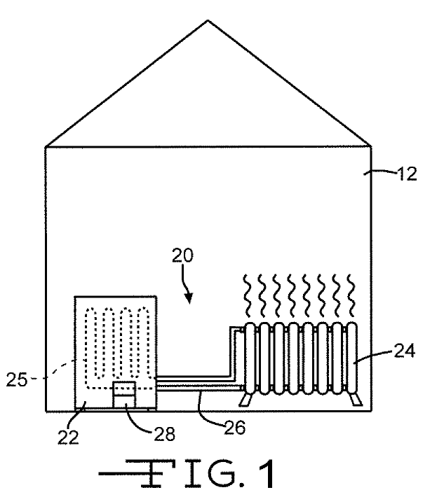

The heat transfer fluid 10 can be used for cooling of tanks, power plants, industrial, commercial and residential buildings, industrial sites, nuclear, gas and diesel engines pumps and other metal or plastic sources which develop heat. The heat transfer fluid 10 can be pumped through power plants, nuclear plants or factories either to heat or cool smoke stacks, nuclear, coal, gas, oil, ethanol or power reactors. The heat transfer fluid 10 does not freeze at sub-zero conditions, and thus will not cause severe pipe damage, corrosion, structural damage, damage to the holding reservoir, boiler or heating and cooling coils or damage to humans and animals. To heat homes and businesses, a heating unit 22 or 32 such as a furnace or boiler is placed either inside or outside the desired structure (FIGS. 1, 2 and 3). The heat transfer fluid 10 can be heated using any well known heat source or energy source including geothermal heating. The heat source can be placed outside the building 12. To use the heat transfer fluid 10 for heating a building 12, the heat transfer fluid 10 is heated from about 145° F. (63° C.) to 230° F. (110° C.) in a furnace, boiler 22 or 32, reservoir or any well known heating unit. For steam boiler heating systems, the heat transfer fluid can be heated to between about 210° F. (99° C.) to 400° F. (204° C.). The heat transfer fluid 10 is then pumped into the radiators 24 or heating coils 34 or 35 in the building 12 to be heated. The heat from the heat transfer fluid 10 pumped throughout the pipes 26 or 36 and radiators 24 or heating coils 34, heats the pipes 26 or 36 and radiators 24 or heating coils 34 or 35, which in turn, heats the air surrounding the pipes 26 and 36 and radiators 24 or heating coils 34 or 35. When the heat transfer fluid 10 has cooled, the heat transfer fluid 10 will flow or be pumped back to the heat source for reheating and recirculation. The heating systems 20 or 30 are regulated by a thermostat or computer controlled environmental system based on the desired temperature or humidity.

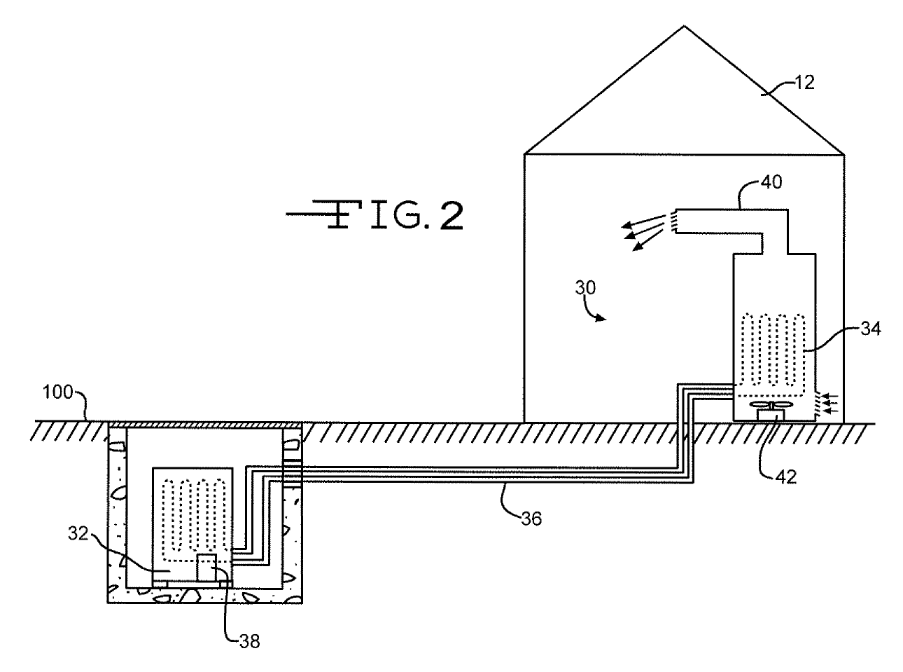

The heat transfer fluid 10 can be used in a forced air heating system 30, a hot water (radiator) heating system 20 or a geothermal heat pump system. In a forced air heating system 30, the heat transfer fluid 10 is heated by the heat source or heating unit 32 and then pumped by a pump 38 through the radiator or heating coils 34 of the furnace system (FIG. 2). Air is then moved over the heating coils 34 and the hot air is pumped or forced through the existing heating duct system 40 by a fan. When using a heat transfer fluid 10 having a mix of 50% by weight neutralized glycerin and 50% by weight water in a heating, or cooling environment, the heating or cooling system 20 or 30 is first filled with the heat transfer fluid 10. Then the pumps are activated and the system 20 or 30 is bled to remove the air (hydrogen and oxygen).

In one (1) embodiment, the heating system is a standard hot water heating system 20, or a base board system where the heat transfer fluid 10 is pumped directly through the piping of the home, business, industrial site, or power plant (FIG. 1). Such a system includes a heating unit or boiler 22 having a heating source and radiators 24 connected to the boiler 22 by piping 26. The system 20 also includes a pump 28 to move the heat transfer fluid 10 through the pipes 26. The heat transfer fluid 10 could be utilized with a standard roller, diaphragm or gear pump. The piping 26 can be inexpensive PVC, flex hose or steel pipe. In this embodiment, the heat transfer fluid 10 must have a flowability which enables the heat transfer fluid 10 to be easily moved through the pipes 26 of the heating system 20. The glycerin can be mixed with water or distilled water to produce a liquid which can be pumped through pipes 26 to heat homes and commercial or industrial sites. In one (1) embodiment, the entire heating system 20 is located within the building 12 (FIG. 1). In this embodiment, the heating system 20 is a closed system. The heat transfer fluid 10 is filled into the pipes 26 of the heating system 20 and the pipes 26 are sealed. The heat transfer fluid 10 is pumped into the piping in the boiler 22. In one (1) embodiment, the piping 26 in the boiler 22 are a set of coils 25 adjacent the heat source. The heat source is activated to heat the heat transfer fluid 10 in the piping 25 adjacent the heat source. Once the heat transfer fluid 10 reaches a predetermined temperature, the heat source is deactivated and the heat transfer fluid 10 is pumped throughout the pipes 26 to the radiators 24. In one (1) embodiment, the heat transfer fluid 10 is heated until it reaches a temperature just below the boiling temperature of the heat transfer fluid 10. In one (1) embodiment, the heat transfer fluid 10 is heated to about 230° F. (110° C.). When the heat transfer fluid 10 reaches the radiators 24, the heat transfer fluid 10 transfers heat to the radiators 24 which transfers heat to the air surrounding the radiators 24. As the heat is removed from the heat transfer fluid 10, the temperature of the heat transfer fluid 10 decreases. When the heat transfer fluid 10 reaches a predetermined low temperature determined by a thermostat, the pump 28 of the system 20 moves the heat transfer fluid 10 back to the boiler 22 and the heat source is activated to heat the heat transfer fluid 10.

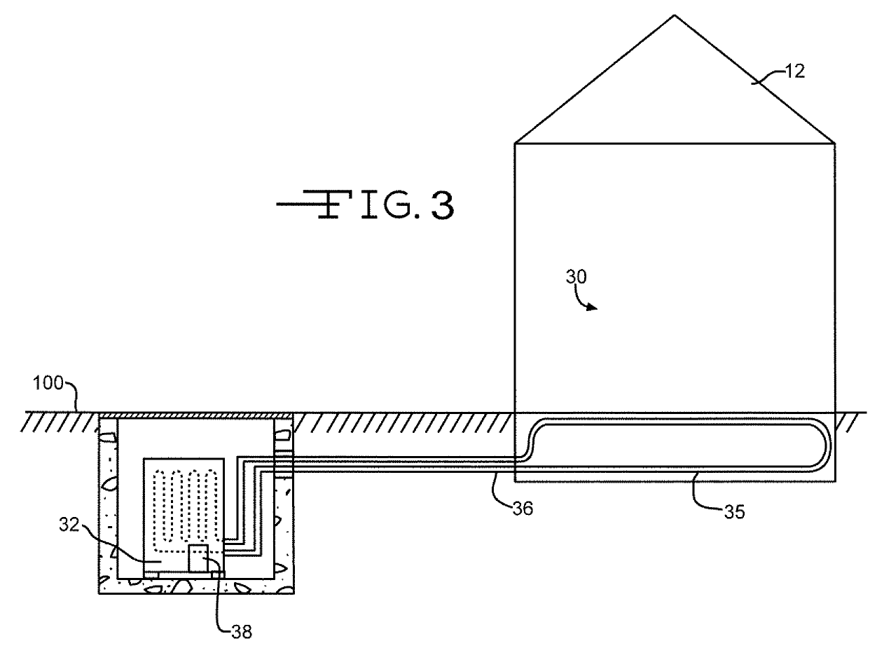

In one (1) embodiment where the heat transfer fluid 10 is used in a heating and cooling system 30 to heat or cool an industrial or residential building, the boiler 32 and pump 38 are located underground outside of the building 12 (FIG. 2). The piping 36 connecting the boiler 32 to the radiators or heating coils 34 in the building 12 is also underground. The heating coils can be located in the floor 14 of the building 12 (FIG. 3). The heating phase works similar to the standard hot water heating system or a forced air heating system 30 with the heat source in the boiler 32 providing heat to the heat transfer fluid 10 and the pump 38 moving the heat transfer fluid 10 to the radiators or heating coils 34 so that the heating coils 34 transfer the heat to air surrounding the heating coils 34. To use the heating and cooling system 30 to cool the building 12, the heat transfer fluid 10 in the system 30 is pumped from the boiler 32 to the radiators or heating coils 34. In this embodiment, the heating coils 34 are cooling coils. Heat is transferred from the air surrounding the cooling coils 34 to the cooling coils 34 and to the heat transfer fluid 10 inside the cooling coils 34. When the heat transfer fluid 10 reaches a predetermined temperature, the heat transfer fluid 10 in the cooling coils 34 is pumped to the boiler 32. In this embodiment, the boiler 32 acts as a storage medium for the heat transfer fluid 10. As the heat transfer fluid 10 is moved through the pipes 36 located beneath the ground 100, the heat of the heat transfer fluid 10 is transferred to the pipes 36 and the surrounding ground 100. The ground 100 surrounding the pipes 36 remains at a constant low temperature between approximately 51° F. (11° C.) and 53° F. (12° C.). As the heat transfer fluid 10 having a temperature greater than approximately 51° F. (11° C.) to 53° F. (12° C.) is moved through the pipes 36, heat is transferred from the heat transfer fluid 10 to the ground 100 which cools the heat transfer fluid 10. After the heat transfer fluid 10 has completely cycled through the heating and cooling system 30, the temperature of the heat transfer fluid 10 is between about 51° F. (11° C.) and 53° F. (12° C.). When the cooled heat transfer fluid 10 reaches the cooling coils 34, the air surrounding the cooling coils 34 transfers heat through the cooling coils 34 to the heat transfer fluid 10 which cools the air and heats the heat transfer fluid 10. A fan 42 can be provided adjacent the cooling coils 34 to increase the flow of air past the cooling coils 34 to increase the rate of cooling of the air. The heat transfer fluid can be used in a chiller. In one (1) embodiment, the chiller is similar to the chiller manufactured by Tempest of Cleveland, Ohio. The chillers are used to super freeze products. In one (1) embodiment, the heat transfer fluid 10 is pumped through pipes and hoses of the chiller and the extreme cold of the heat transfer fluid 10 freezes the pipes and hoses which in turn freezes the surrounding air causing the air to quick freeze. In one (1) embodiment, the heat transfer fluid 10 is super chilled by placing the pipes and hoses of the chiller in liquid nitrogen, Freon, or dry ice and then running the heat transfer fluid 10 through the pipes and hoses to chill the heat transfer fluid 10. The chilled heat transfer fluid 10 is then pumped to the source to be frozen or cooled.

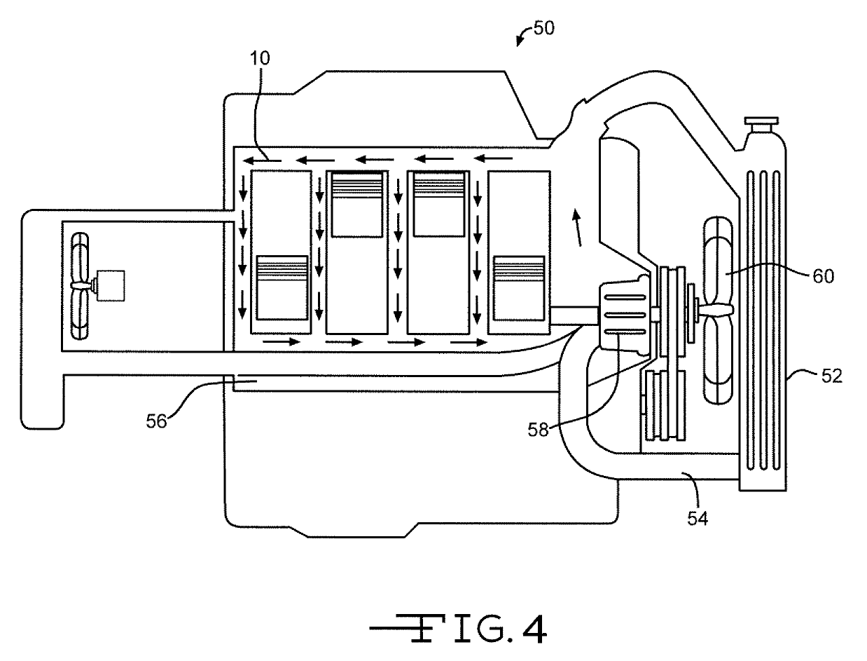

In one (1) embodiment, the heat transfer fluid 10 is used in the radiator of a vehicle engine cooling system 50 to act as the coolant (FIG. 4). As a coolant in an engine cooling system 50, the heat transfer fluid 10 would reduce corrosion. In one (1) embodiment, the engine cooling system 50 is a conventional vehicle cooling system having a radiator 52 connected by hoses 54 to the engine block 56 and having a pump 58 to move the heat transfer fluid 10 through the engine block 56 and the radiator 52. The engine cooling system 50 also includes a fan 60 to move air past the radiator 52 to cool the radiator 52. The heat transfer fluid 10 is filled into the engine cooling system 50. The heat transfer fluid 10 replaces anti-freeze normally used in an engine cooling system 50. When the engine heats up to a predetermined temperature, the pump 58 of the engine cooling system 50 is activated to move the heat transfer fluid 10 through the engine block 56. As the heat transfer fluid 10 moves through the engine block 56, the heat from the engine block 56 is transferred to the heat transfer fluid 10. The heat transfer fluid 10 is then moved to the radiator 52. As the heat transfer fluid 10 moves along the coils of the radiator 52, the fan 60 moves air past the coils of the radiator 52 which transfers the heat of the heat transfer fluid 10 to the air and out of the engine. The circulation time is regulated by the thermostat within the engine's cooling system. If the engine overheats, a computer chip would shut down the engine or a leak in the engine cooling system 50 occurs. The cooled heat transfer fluid 10 is then circulated back through the engine block 56 to repeat the cooling process. The cooling system 50 of the vehicle can also be connected to the heating system of the vehicle to use the heated heat transfer fluid 10 to heat the vehicle as regulated by a thermostat.

It is intended that the foregoing description be only illustrative of the present invention and that the present invention be limited only by the hereinafter appended claims.

I claim:

1. A heat transfer fluid which comprises glycerin.

2. The heat transfer fluid of claim 1 further comprising at least 50% by weight glycerin.

3. The heat transfer fluid of claim 1 further comprising at least 60% by weight glycerin.

4. The heat transfer fluid of claim 1 wherein the glycerin is a by-product of biodiesel production.

5. The heat transfer fluid of claim 4 wherein the glycerin is derived from plants or animals and is not petroleum based.

6. The heat transfer fluid of claim 4 wherein the glycerin contains less than 3% methanol.

7. The heat transfer fluid of claim 1 wherein the glycerin contains at least about 60% by weight glycerol.

8. The heat transfer fluid of claim 1 further comprising one or more ingredients selected from the group consisting of water, salts, calcium chloride, sodium chloride, magnesium chloride, potassium chloride, acetates and mixtures thereof.

9. The heat transfer fluid of claim 1 further comprising one or more ingredients selected from the group consisting of desugared molasses, lignins, whey, brewers yeast, lanolin, condensed corn fermented extractives, corn condensed distillers solubles and mixtures thereof.

10. The heat transfer fluid of claim 1 further comprising one or more ingredients selected from the group consisting of alcohols, glycols, windshield washer solvent and mixtures thereof.

11. The heat transfer fluid of any one of claims 8, 9, or 10 wherein an amount by weight of the ingredient in the heat transfer fluid is greater that an amount by weight of glycerin in the heat transfer fluid.

12. The heat transfer fluid of claim 11 wherein a mix of 50% by weight glycerin and 50% by weight water is included with the ingredients in the heat transfer fluid and wherein the mix comprises between about 0.005% to 70% by weight of the heat transfer fluid.

13. The heat transfer fluid of claim 1 wherein the heat transfer fluid has a freezing point of at least greater than −45° F. (−43° C.) and a boiling point of greater than 350° F. (177° C.).

14. The heat transfer fluid of claim 1 wherein the heat transfer fluid has a corrosion level of less than 3 mg per day at 220° F. (104.4° C.).

15. A method for conducting heat transfer in a heating or cooling system, which comprises the steps of:
(a) providing a heat transfer fluid in the heating or cooling system wherein the heat transfer fluid includes glycerin; and
(b) conducting heat transfer between the heat transfer fluid and the heating or cooling system.

16. The method of claim 15 wherein the glycerin is a by-product of a production of bio-diesel.

17. The method of claim 15 wherein the heat transfer fluid further comprises water, salts, calcium chloride, sodium chloride, magnesium chloride, potassium chloride, acetates, desugared molasses, lignins, whey, brewers yeast, lanolin, condensed corn fermented extractives, corn condensed distillers solubles and mixtures thereof.

18. The method of claim 15 wherein the heat transfer fluid further comprises an alcohol selected from the group consisting of ethanol, ethylene glycol, ethyl alcohol, isopropyl alcohol, methyl alcohol and propylene glycol and combinations thereof.

19. The method of claim 15 wherein the heat transfer fluid has a pH in a range of 5 to 9.

20. The method of claim 15 wherein the heat transfer fluid has a boiling point of greater than 350° F. (177° C.).

21. The method of claim 15 wherein further in step (b) the heat transfer fluid is heated to a temperature of at least 145° F. (63° C.)

22. The method of claim 15 wherein the heating or cooling system has a boiler, pipes, a radiator, and a pump, wherein the heat transfer fluid is heated by the boiler and moved through the pipes to the radiator by the pump and wherein heat is transferred from the heat transfer fluid to the radiator and to air surrounding the radiator.

23. The method of claim 22 wherein the glycerin of the heat transfer fluid providing lubricant for the pump.

24. The method of claim 15 wherein the heating and cooling system has a pump and a storage tank connected to a radiator in a building by pipes, wherein the pipes are located underground, wherein the heat transfer fluid is pumped from the storage tank through the pipes to the radiator and wherein in step (b), as the heat transfer fluid is moved through the pipes, the heat is transferred from the heat transfer fluid to the ground so that the heat transfer fluid is cooled and heat is transferred to the heat transfer fluid from the radiator from air surrounding the radiator to cool the air in the building.

25. A method of heat transfer comprising the steps of:
(a) providing an object to be heated or cooled; and
(b) transferring heat to or from the object to be heated or cooled by means of a heat transfer fluid, the heat transfer fluid comprising glycerin.

26. The method of claim 25 wherein the heat transfer fluid further comprises an alcohol selected from the group consisting of ethanol, ethylene glycol, ethyl alcohol, isopropyl alcohol, methyl alcohol and propylene glycol and combinations thereof.

27. The method of claim 25 wherein the heat transfer fluid has a pH in a range of 5 to 9.

28. The method of claim 25 has a boiling point of greater than 350° F. (177° C.).

29. The method of claim 25 wherein the object is a vehicle having a radiator and an engine block, wherein the heat transfer fluid is moved through the engine block to transfer heat from the engine block to the heat transfer fluid and wherein the heat transfer fluid moves through the radiator to transfer heat from the heat transfer fluid to the radiator and to air surrounding the radiator.

30. The method of claim 25 wherein the object is a building having a heating system with a pump and a boiler connected to a radiator by pipes, wherein the heat transfer fluid is in the pipes, wherein before step (b), the heat transfer fluid is moved into contact with the boiler so that heat is transferred from the boiler to the heat transfer fluid and wherein in step (b), heat is transferred from the heat transfer fluid to the radiator and from the radiator to air surrounding the radiator in the building to heat the air in the building.
